(19) United States
(12) Patent Application Publication
(10) Pub. No.: US 2021/0172873 A1
(43) Pub. Date: Jun. 10, 2021

(54) APPARATUS FOR OPTICAL DETECTION OF CONTAMINATION, RADIATION SOURCE, METHOD FOR OPTICAL DETECTION OF CONTAMINATION

(71) Applicant: Oxford University Innovation Limited, Oxford (GB)

(72) Inventor: Stephen COLLINS, Oxford (Oxfordshire) (GB)

(21) Appl. No.: 16/771,242

(22) PCT Filed: Dec. 7, 2018
(86) PCT No.: PCT/GB2018/053566

§ 371 Date: Jun. 10, 2020

(30) Foreign Application Priority Data
Dec. 13, 2017 (GB) 1720772.1

(51) Int. Cl. G01N 21/64; G02B 19/00; G01N 21/94

(52) U.S. Cl. CPC G01N 21/645; G02B 19/0076; G01N 2021/6463; G01N 21/94; G01N 21/6486

(57) ABSTRACT

Apparatus and methods for optical detection of contamination are disclosed. In one arrangement, an excitation source (24) directs excitation radiation (26) into or onto an entity (22) to be tested. A first optical concentrator (28) is configured to receive radiation emitted due to fluorescence indicative of contamination in or on the entity (22). The emitted radiation (30) is received via an input surface (32). Concentrated radiation is output via an output surface (34). The first optical concentrator (28) comprises a first wavelength converting element that converts the received radiation to longer wavelength radiation prior to the output of the radiation via the output surface (34). A detection system (38) detects radiation output from the output surface of the first optical concentrator.

The present disclosure relates to methods and apparatus for detecting contamination, particularly in the context of food or waste water testing.

Detection of food residues on cleaned food processing equipment has been demonstrated using imaging systems, some of which use fluorescence of the food residue to detect this form of contamination. Although bacteria are known to be associated with characteristic fluorescence responses these systems have not been used to detect bacterial contamination. Instead the commonly used approaches for detecting bacterial contamination of food processing equipment rely on swabbing of portions of the relevant surfaces. Such swabbing cannot test all of the relevant surfaces and reliability can be compromised by uncontrollable factors such as the pressure exerted on the swab.

One domain in which fluorescence is exploited to detect contamination is in the water industry. In particular, in this industry a particular fluorescence response is known to be associated with contamination that leads to a high biological oxygen demand (BOD). Currently, the water industry relies upon the immersion of detection apparatus, but this cannot be used continuously because of fouling. This means that these sensors can be used only at particular times.

Spectrofluorometers are known for measuring fluorescence of samples in the laboratory, but these devices are relative large and expensive.

It is an object of the invention to provide an alternative approach for optically detecting contamination.

According to an aspect of the invention, there is provided an apparatus for optical detection of contamination, comprising: an excitation source configured to direct excitation radiation into or onto an entity to be tested; a first optical concentrator configured to: receive radiation emitted due to fluorescence indicative of contamination in or on the entity, the radiation being received via an input surface; and output concentrated radiation via an output surface, wherein the first optical concentrator comprises a first wavelength converting element configured to convert the received radiation to longer wavelength radiation prior to the output of the radiation via the output surface; and a detection system configured to detect radiation output from the output surface of the first optical concentrator.

Thus, an apparatus is provided that is able to detect contamination efficiently without making contact with the entity being tested. In the case of monitoring liquids, there is no need for immersion of sensors, thereby reducing or eliminating the possibility of fouling. The use of an optical concentrator comprising a wavelength converting element provides a large collection area for the fluorescence and/or a wide field of view. The result is a higher light intensity on the photodetector used to sense the fluorescence, which increases the sensitivity of the system. This increased sensitivity means that smaller levels of contamination can be detected and/or the power of the excitation source can be reduced to improve safety and/or reduce power consumption.

In an embodiment, the apparatus further comprises a modulator configured to apply a modulation to the excitation radiation such that a corresponding modulation is present in the emitted radiation received by the first optical concentrator. Modulating the excitation radiation makes it possible to distinguish more accurately between emitted radiation of interest and other sources of radiation.

In an embodiment, the modulator is configured to apply modulation at a plurality of different modulation frequencies; and the data processing unit is configured to distinguish between detected radiation resulting from fluorescence excited by radiation with each of the different modulation frequencies. In an embodiment, the excitation radiation comprises a plurality of excitation components, each excitation component consisting of radiation within a different band; and each excitation component is modulated at a different modulation frequency. This makes it possible to distinguish between fluorescence originating from different bands of excitation radiation. Different contaminants may therefore be measured independently of each other. It is possible to obtain a similar effect by using filters to detect fluorescence in narrow bands that exclusively or predominantly correspond to an excitation of interest, but due to the generally wide bandwidth of fluorescence this will involve losing a significant proportion of the signal. Furthermore, in contrast to an arrangement in which independent sensors are used to measure different contaminants, the present embodiment uses the same collector to receive radiation from all of the excitation components. This facilitates provision of a compact device and/or maximises device sensitivity by increasing the proportion of a total amount of fluorescence that is detected.

In an embodiment, the apparatus comprises an excitation source monitor configured to monitor an output from the excitation source. In an embodiment, the excitation source monitor comprises a second wavelength converting element configured to convert invisible radiation to visible radiation and output the visible radiation to the environment for direct viewing by a user. Thus, a visible indication that the excitation source is in operation is provided to the user directly, without requiring potentially unreliably intermediate steps such as detection of the excitation radiation by a detector and data processing of an output of the detector. A high level of safety and reliability is therefore provided at low cost.

In an embodiment, the apparatus comprises an elongate conduit or elongate receptacle comprising a an entity to be tested in liquid form, wherein the first optical concentrator, or a plurality of first optical concentrators, azimuthally surround an axis of elongation of the elongate conduit or elongate receptacle through at least 180 degrees. This arrangement allows a high proportion of emitted radiation to be captured. Device sensitivity is thus increased.

According to an aspect, there is provided a radiation source configured to emit invisible radiation, comprising a wavelength converting element configured to convert a portion of the invisible radiation emitted by the radiation source to visible radiation and emit the visible radiation to the environment for direct viewing by user. Thus, a visible indication that the radiation source is in operation is provided to the user directly without requiring potentially unreliably intermediate steps such as detection of the radiation by a detector and data processing of an output of the detector. A high level of safety and reliability is therefore provided at low cost.

According to an aspect, there is provided a method for optical detection of contamination, comprising: directing excitation radiation into or onto an entity to be tested; using a first optical concentrator to receive radiation emitted due to fluorescence indicative of contamination in or on the entity, the radiation being received via an input surface, and to output concentrated radiation via an output surface, wherein the first optical concentrator comprises a first wavelength converting element that converts the received radiation to longer wavelength radiation prior to the output of the radiation via the output surface; and detecting radiation output from the output surface of the first optical concentrator.

Embodiments of the invention will now be described, by way of example only, with reference to the accompanying drawings in which corresponding reference symbols represent corresponding parts, and in which:

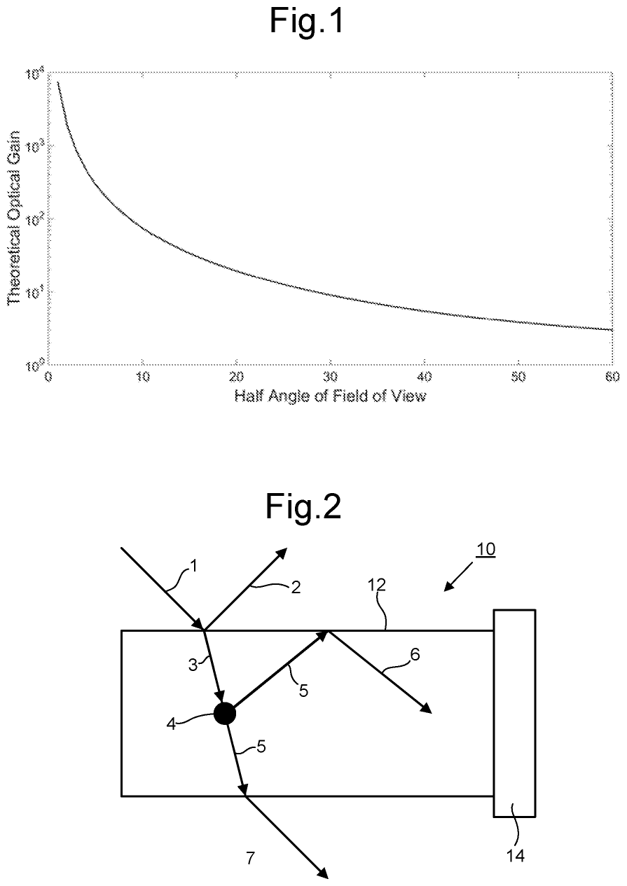

FIG. 1 depicts a relationship between an étendue limited maximum gain and the half angle of the field of view of a concentrator;

FIG. 2 depicts the principle of operation of a concentrator having a wavelength converting element based on photoluminescence;

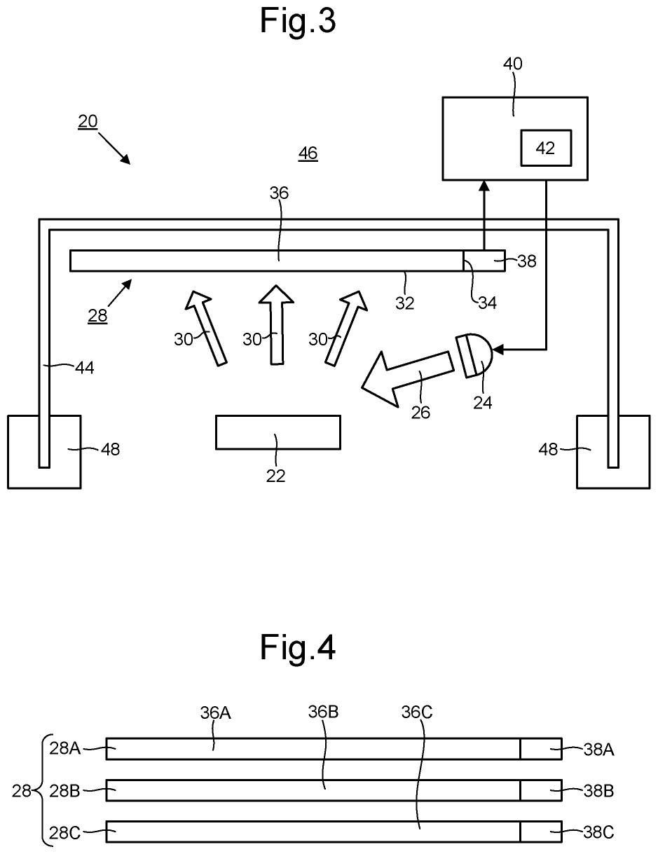

FIG. 3 is a schematic side sectional view of an apparatus for optical detection of contamination comprising an enclosure;

FIG. 4 is a schematic side sectional view of three optical concentrators in series;

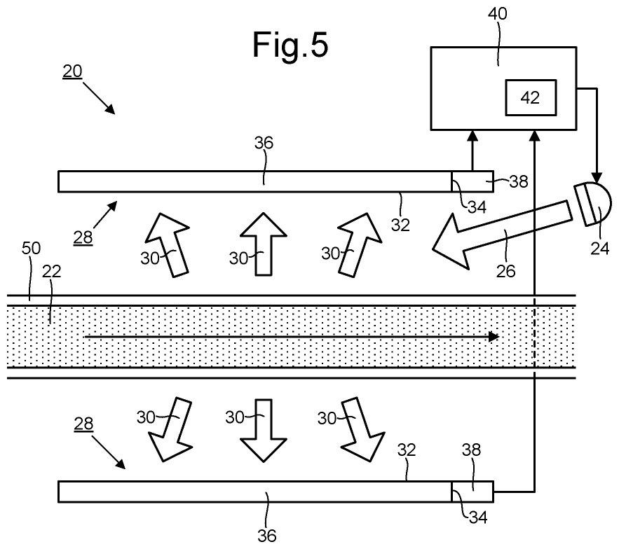

FIG. 5 is a schematic side sectional view of an apparatus for optical detection of contamination in a liquid target material in an elongate conduit;

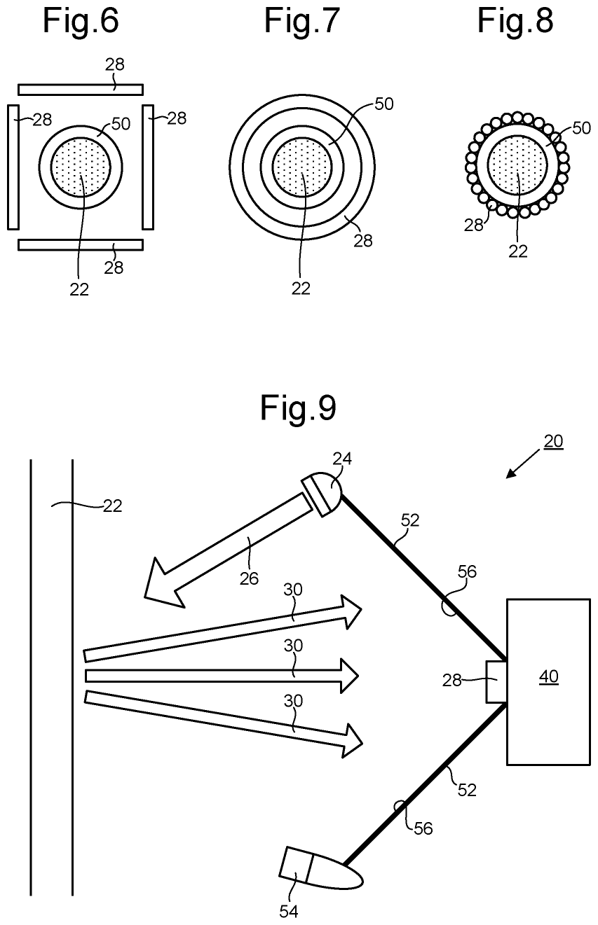

FIG. 6 is a schematic end sectional view of an apparatus of the type shown in FIG. 5 with four planar optical concentrators;

FIG. 7 is a schematic end sectional view of an apparatus of the type shown in FIG. 5 with a tubular optical concentrator;

FIG. 8 is a schematic end sectional view of an apparatus of the type shown in FIG. 5 with a plurality of optical concentrators provided as fibres;

FIG. 9 is a schematic side sectional view of an apparatus for optical detection of contamination comprising an optical concentrator and a reflection system;

FIG. 10 is a schematic side sectional view of an apparatus for optical detection of contamination configured to facilitate localisation of an area of contamination by positioning the excitation source centrally;

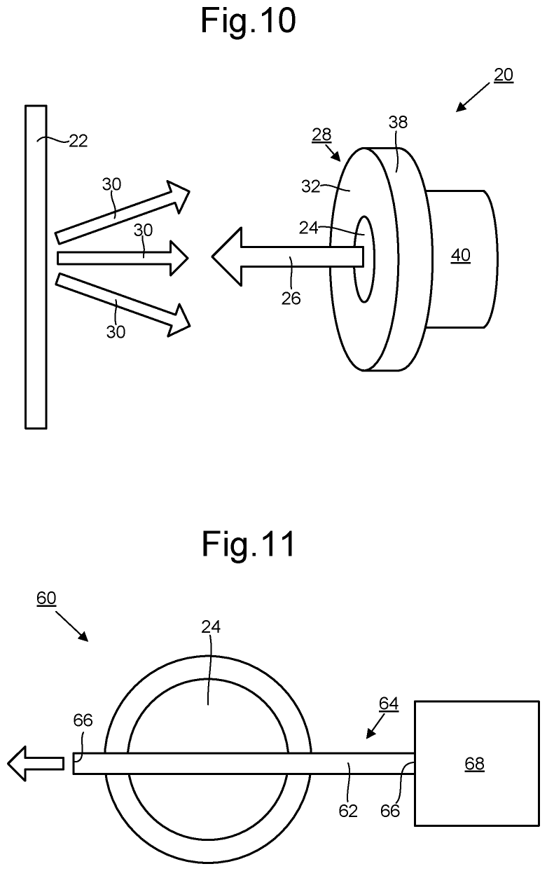

FIG. 11 is a schematic view along an axis of an excitation source of an excitation source monitor.

Embodiments of the present disclosure relate to detecting fluorescence from contamination with high sensitivity. A first step to creating a sensitive system is to collect as much of the emitted light as possible. The first challenge when detected fluorescence is that light is emitted equally in all directions. This light is relative easy to collect if the detector can be put very close to the illuminated area. However, this is not always possible, for example because the user is avoiding touching a ‘clean’ surface, or because there is a risk of fouling the sensor. Further challenges may arise where a relatively large area needs to be tested quickly or where the necessary detectors are relatively costly and therefore each detector has to cover a relatively large area. In these situations the sensor needs to collect light over an area that can be significantly larger than any available or affordable detector.

Optical elements, such as lenses or compound parabolic reflectors based upon reflection or refraction could be used to collect light over a large area and concentrate it onto a detector with a smaller area. However, these physical processes conserve étendue and this means that a large optical gain can only be achieved at the expense of restricting the field of view of the detector. In addition, when these processes are used to achieve large optical gains the optical elements are large 3D structures.

Conservation of étendue (constant radiance theorem) means that the maximum gain, Gₘₐₓ, for a concentrator with a field of view θ is given by

$${G}_{max} = \frac{{n}^{2}}{{sin}^{2} θ} ,$$

where n is the refractive index of the concentrator.

The relationship between the étendue limited maximum theoretical optical gain and the half angle of the field of view of a concentrator is shown in FIG. 1. This shows that high gains are possible but significantly reduce the field of view (FOV). A gain of around 1000 will be associated with a FOV of about 3° for example.

Changing the wavelength of radiation during the concentration process, using photoluminescence for example, allows gains and/or fields of view to be achieved which are not constrained by conservation of étendue, and which can therefore be more favourable. Examples of arrangements based on this principle are disclosed for example in GB 2506383A and in ‘High gain, wide field of view concentrator for optical communications’, Steve Collins, Dominic C. O'Brien and Andrew Watt, OPTICS LETTERS, Vol. 39, No. 7, pp1756-1759 Apr. 1, 2014.

Optical concentration refers to the process of receiving light using a relatively large collecting aperture and concentrating that light onto a much smaller area, such that the photon flux density on the smaller area is larger than the photon flux density on the larger area.

The principle of operation of a concentrator 10 comprising a wavelength converting element based on photoluminescence is illustrated schematically in FIG. 2. Light 1 is incident on the front surface 12 of the concentrator 10, which acts as a collecting area (input surface) of the concentrator 10. Some of this incident light will be reflected from the surface 12 (arrow 2) but most of the light will be transmitted into the concentrator 10 (arrow 3). Some of transmitted incident light will be absorbed by luminophores 4 (e.g. fluorophores or phosphors) within the concentrator 10. Any luminophore that has been excited by a photon of incident light might emit a photon with a longer wavelength in a random direction (arrows 5). Some of this emitted light will escape from the concentrator 10 (arrow 7) but most of it will be retained with the concentrator 10 by total internal reflection (arrow 6). If re-absorption by the luminophore at the new wavelength is negligible this light will reach a detector 14 at an edge of the concentrator 10. Even if the retained light is absorbed by the luminophore before it reaches the detector 14 it can still be emitted at an even longer wavelength, be retained by total internal reflection and reach the detector 14.

Embodiments of the present disclosure exploit the above ideas to provide methods and apparatus for efficiently detecting contamination in or on an entity to be tested.

FIG. 3 depicts an exemplary apparatus 20 for optical detection of contamination in or on an entity 22 to be tested. The apparatus 20 comprises an excitation source 24. The excitation source 24 directs excitation radiation 26 (e.g. UV light) onto the entity 22. A first optical concentrator 28 receives radiation 30 emitted due to fluorescence indicative of contamination in or on the entity 22. The fluorescence is excited by the excitation radiation 26.

A range of contaminants of interest contain characteristic fluorophores. Excitation of these fluorophores causes radiation to be emitted. Embodiments of the present disclosure allow such emitted radiation to be detected reliability and with high sensitivity, thereby making it possible to measure levels of contamination in real time with high accuracy.

Embodiments are particularly applicable to detecting microbial contamination. Cellular activity in living microbes produces characteristic fluorophores such as reduced pyridine nucleotides, oxidized flavins, and other coenzymes and metabolites. Microbial spores contain high levels of a fluorescent calcium dipicolinic acid complex. Each of these fluorophores are excitable via radiation within a first characteristic band particular to the fluorophore and will emit radiation in a second characteristic band particular to the fluorophore. Detailed information about excitation and emission wavelength ranges for various substances relevant to contamination have been collected from work in the water and food industries and are widely available. Many substances indicative of contamination are excited by UV light.

Returning to FIG. 3, the radiation emitted due to fluorescence (of contaminants) is received via an input surface 32 of the first optical concentrator 28. Concentrated radiation is output via an output surface 34. In an embodiment, the first optical concentrator 28 operates according to the same principles as the optical concentrator 10 described above with reference to FIG. 2.

In an embodiment, the first optical concentrator 28 comprises a first wavelength converting element 36. The first wavelength converting element 36 converts the received radiation 30 to longer wavelength radiation prior to output of the radiation 30 via the output surface 34. The first wavelength converting element 36 absorbs radiation of a first wavelength or first wavelength band and re-emits the radiation at a second wavelength or second wavelength band different to the first. The conversion involves shifting power from shorter wavelengths towards longer wavelengths. In an embodiment, the wavelength converting element 28 has a short response time, for example of 1 microsecond or less, optionally 10 nanoseconds or less, optionally 1 nanosecond or less, but this is not essential.

In an embodiment, the first wavelength converting element 36 comprises luminophores (fluorophores or phosphors). In an embodiment, the first wavelength converting element 36 comprises fluorescent dye. Alternatively or additionally, the first wavelength converting element 36 comprises quantum dot wavelength converters, for example solution processed quantum dots. Solution processed quantum dots have tuneable absorption and emission characteristics, large luminescence quantum yields and Stokes shifts compatible with minimal re-absorption losses.

In an embodiment, the first wavelength element 36 is configured to do one or more of the following: convert infrared or near-infrared radiation to infrared radiation or near-infrared radiation having a longer wavelength, convert UV radiation to visible radiation, convert UV radiation to infrared or near-infrared radiation, convert visible radiation to visible radiation having a longer wavelength, and convert visible radiation to infrared or near-infrared radiation.

The shape of the first wavelength converting element 36 is not particularly limited. In an embodiment, the first wavelength converting element 36 has a thickness that is smaller than the length and/or width of the first wavelength converting element 36. In an embodiment, the first wavelength converting element 36 has a substantially sheet-like form, for example having a thickness that is at least 10 times, optionally at least 50 times, optionally at least 100 times, smaller than the length and/or width of the first wavelength converting element 36. A large collection area (input surface 32) can therefore be provided easily and/or shaped to capture radiation effectively. In an example embodiment, the first wavelength converting element 36 is substantially planar.

In an embodiment, the first optical concentrator 28 comprises a confinement structure (not shown) that allows passage of radiation having a wavelength suitable for conversion by a first wavelength converting element 36 in the confinement structure, from the outside of the confinement structure to the inside of the confinement structure, and substantially to block passage of radiation that has been converted by the first wavelength converting element 36 from the inside of the confinement structure to the outside of the confinement structure. Converted radiation may thus be directed efficiently to the output surface 34 via internal reflections from the confinement structure. The confinement structure thus reduces losses. The confinement structure may comprise two substantially planar elements (e.g. dichroic plates) with the first wavelength converting element 36 located in between the two substantially planar elements. Converted radiation is trapped by the two planar elements and guided towards the output surface 34.

Where the first optical concentrator 28 comprises a confinement structure, the confinement may concentrate radiation towards the output surface 34 of the first optical concentrator 28. The confinement structure may be provided with a filter, such as a log-pass optical filter, for reducing or preventing entry of scattered excitation radiation into the confinement structure.

In an embodiment, the apparatus 20 further comprises an enclosure 44 capable of at least partially optically isolating at least the entity 22, during the receiving of the emitted radiation 30 by the first optical concentrator 28, from the outside environment 46. In an embodiment, the enclosure 44 further optically isolates either or both of the excitation source 24 and the first optical concentrator 28 from the outside environment 46. The enclosure 44 prevents interference from ambient light, for example surrounding the optically isolated components to block off at least 90% of ambient light, optionally at least 95%, optionally at least 99%. The enclosure 44 further makes the system eye safe for any excitation power. Embodiments of this type can be used to detect contamination in or on any entity that can be positioned at least partially within the enclosure 44 or in close proximity to an opening of the enclosure. In some embodiments, the apparatus 20 is attached to the end of a supporting arm and positioned to float at a fixed height above an open body of water so that it can sample light (through an opening in the enclosure 44) emitted from the surface of water that needs to be monitored continuously but which might foul any immersed sensor, for example river or waste water. In the particular example depicted in FIG. 3, floats 48 are attached to the enclosure to increase a buoyancy of the apparatus 20. The apparatus 20 may even be configured to float without a supporting arm.

In an embodiment, the apparatus 20 further comprises a detection system 38. The detection system 38 detects radiation output from the output surface 34 of the first optical concentrator 28. The detection system 38 may comprise any suitable detector, for example a photo multiplier tube (PMT) detector, or a silicon device that can count photons (sometimes referred to as silicon photo-multipliers (SiPMs) or single-photon avalanche diodes. The latter devices are cheaper than PMT detectors, and typically cheaper even than typical UV LEDs that emit wavelengths below 340 nm and that can be used to excite some of the fluorescence peaks of interest. In other embodiments, photodiodes (e.g. avalanche or PIN) may be used.

An output from the detection system 38 may be provided to a data processing unit 40. The data processing unit 40 may comprise any known computing hardware, firmware and/or software suitably programmed to provide the functionality required. In an embodiment, the data processing unit 40 comprises a trans-impedance amplifier and FPGA.

The data processing unit 40 uses the results of the detection to determine information about contamination in or on the entity 22. In an embodiment, information about contamination is determined based on a measured intensity of fluorescence from the entity 22. When interpreting the measured intensity, one or more properties of the excitation radiation (e.g. intensity) may be taken into account. Such properties may be measured and provided to the data processing unit 40 by an excitation monitor (described in further detail later in this disclosure).

In an embodiment, the apparatus 20 further comprises a modulator 42. In the example of FIG. 3, the modulator 42 is provided as part of the data processing unit 40. In other embodiments, the modulator 42 is implemented independently of the data processing unit 40. The modulator 42 applies a modulation to the excitation radiation 26. The modulation is such that a corresponding modulation is present in the emitted radiation 30 received by the first optical concentrator 28. In an embodiment, the modulation comprises amplitude or phase modulation. In an embodiment, the modulation is characterized by a frequency of modulation, such as the frequency at which the amplitude or phase is modulated. In an embodiment, the data processing unit 40 uses the modulation applied by the modulator 42 to distinguish detected radiation resulting from fluorescence excited by excitation radiation having the same modulation from radiation from other sources or radiation with other modulations. The modulation thus reduces interference from other sources of radiation. The modulation allows low frequency noise in the detection system 38 and associated electronics to be rejected.

In an embodiment, the modulator 42 applies modulation at a plurality of different modulation frequencies. In such embodiments, the data processing unit 40 can distinguish, independently of each other, detected radiation resulting from a corresponding plurality of excitations. In an embodiment of this type, the excitation radiation may be arranged to comprise a plurality of excitation components that are each modulated with a different modulation frequency. Each excitation component may consist of radiation within a different band. Each band may, for example, be centred at a different radiation wavelength and may or may not overlap with any other bands. Each excitation component is modulated at a different modulation frequency. Thus, excitation radiation in different bands may be arranged to have different modulations. This makes it possible to distinguish between fluorescence originating from different bands of excitation radiation. In some embodiments, the excitation components respectively comprise radiation in different bands that respectively correspond to different contaminants of interest. Each band may, for example, contain radiation suitable for exciting one or more fluorophores known to be associated with a particular contaminant. The different contaminants may therefore be measured independently of each other. Furthermore, in contrast to an alternative arrangement in which independent sensors are used to measure different contaminants, the present embodiment uses the first optical concentrator 28 (i.e. including the same input surface 32 and output surface 34) and detection system 38 to receive and detect radiation from all of the excitation components. This facilitates provision of a compact device and/or maximises device sensitivity by increasing the proportion of a total amount of fluorescence that is detected. In addition, fewer separate detection systems 38 are required, which may be particularly desirable where relatively expensive PMT detectors are used.

Although in the example of FIG. 3 only one excitation source 24 is shown, multiple excitation sources could be used. The response from each can be distinguished as described above by modulating the different excitation sources at different frequencies. Alternatively or additionally, different excitation sources could be switched on at different times (which might be preferable where responses from different excitation sources are expected to differ in strength significantly). Thus, the different excitation sources could be modulated into a square wave form comprising periods when the excitation source is on (square wave plateaux) and periods when the excitation is off (square wave troughs). Each excitation source may then be phase shifted to ensure that no two excitation sources are on at the same time. The different excitation sources may thus be time division multiplexed.

In an embodiment, the data processing unit 38 uses a combination of the distinguished detected radiation from different modulations to extract levels of a plurality of different fluorophores in or on the entity 22 that have different fluorescence decay lifetimes. This is possible even without providing different modulations to excitation components in different bands. The principle is described below.

Fluorophores and phospors are characterised by a decay lifetime. For fluorophores this lifetime is typically measured in nanoseconds. For phosphors the lifetime can be microseconds or longer. If the phosphor's response is characterised by a single lifetime its frequency response is analogous to the frequency response of a single pole low-pass filter. This means that for a lifetime τ and modulation frequency f the response of the phosphor is

$$R ( f ) = \frac{1}{1 + j 2 π f τ}$$

This has two important effects. For modulation frequencies greater than approximately 1/(2πτ) the amplitude of the response decreases as the frequency increases. In addition, for frequencies between 0.1/(2πτ) and 10/(2πτ) the response of the phosphor introduces a phase shift between the absorbed and emitted light which increases as frequency increases.

The frequency response of the phosphors and fluorophores can be used to distinguish between responses from different contaminants to excitation radiation in the same wavelength band without losing any light by filtering. This approach may be particularly advantageous in situations where the contaminants of interest have similar (e.g. overlapping) excitation and emission bands (such as ATP and tryptophan).

In an exemplary embodiment discussed below, the first optical concentrator 28 comprises two luminophores (i.e. fluorophore or phosphor) having different lifetimes, with one having a substantial response to wavelengths between 400 nm and approximately 450 nm and another with a substantial response between 450 nm and approximately 570 nm. The excitation source 24 could then be modulated at two frequencies with one frequency chosen to be low enough to allow both luminophores to respond and the other frequency chosen so that the luminophore with the longest lifetime has an attenuated and phase-shifted response. After detection and amplification the detector response could be digitised and the two frequencies separated as follows:

$$S ( {f}_{1} ) = \frac{{A}_{1}}{1 + j 2 π {f}_{1} {τ}_{1}} + \frac{{A}_{2}}{1 + j 2 π {f}_{1} {τ}_{2}}$$

$$S ( {f}_{2} ) = \frac{{A}_{1}}{1 + j 2 π {f}_{2} {τ}_{1}} + \frac{{A}_{2}}{1 j 2 π {f}_{2} {τ}_{2}}$$

If f₁ is low enough the sensor response at this frequency is

S(f₁)=A₁+A₂

A higher second frequency can then be chosen such that

$$S ( {f}_{2} ) = {A}_{1} + \frac{{A}_{2}}{1 + j 2 π {f}_{2} {τ}_{2}}$$

If f₂ is such that 2πf₂τ₂>>1 but 2πf₂τ₁<1

S(f₂)=A₁

This simplifies the analysis of the data. However, it may not be possible to ensure that 2πf₂τ₂>>1 and so

$$S ( {f}_{2} ) = {A}_{1} + \frac{{A}_{2}}{1 + j 2 π {f}_{2} {τ}_{2}}$$

and in this case

$$S ( {f}_{1} ) - S ( {f}_{2} ) = {A}_{2} - \frac{{A}_{2}}{1 + j 2 π {f}_{2} {τ}_{2}} = {A}_{2} \frac{j 2 π {f}_{2} {τ}_{2}}{1 + j 2 π {f}_{2} {τ}_{2}}$$

The ratio between A₁ and A₂ can then be used to differentiate, for example, between dead cells and both viable cells or spores. When excited by radiation at 365 nm, dead cells fluoresce predominantly in the range of about 450 nm to about 570 nm, whereas viable cells and spores fluoresce over a wider range from about 400 nm to about 570 nm.

An advantage of using the ratio of responses in different wavelength ranges to the same excitation source is that the result is independent of the intensity of the light from the excitation source. In alternative approaches which use different excitation sources it is necessary to monitor the intensity of each of the excitation sources accurately. The present approach is therefore simpler.

In an embodiment, as depicted schematically in FIG. 4, a plurality of the first optical concentrators 28A-C is provided, optionally optically in series with each other, such that radiation emitted from the entity 22 (e.g. from above in the example of FIG. 4) passes through each of the first optical concentrators 28A-C one after the other in sequence (with a portion of the radiation being absorbed in each first optical concentrator 28A-C as it passes through). Each first optical concentrator 28A-C comprises a first wavelength converting element 36A-C that is configured to convert received radiation in an input band to longer wavelength radiation in an output band. At least the input band is different for each of the first optical concentrators 28A-C. Thus, each different first wavelength converting element 36A-C may comprise different luminophores and/or different filters. Each first optical concentrator 28A-C has an associated detection system 38A-C, which allows an output from each first optical concentrator 28A-C to be measured independently. Thus, each of the first optical concentrators 28A-C can be configured to predominantly detect fluorescence from different contaminants or different combinations of contaminants. For example, when excited by radiation at 365 nm, dead cells fluoresce predominantly in the range of about 450 nm to about 570 nm, whereas viable cells and spores fluoresce over a wider range from about 400 nm to about 570 nm. By arranging for one of the first optical concentrators 28A-C to detect exclusively in the range 400 nm to 450 nm (thereby excluding dead cells) and for another of the first optical concentrators 28A-C to detect exclusively in the range of 450 nm to 570 nm, it is possible to distinguish live cells and spores from dead cells by calculating the ratio of emissions between 400 nm and 450 nm with emissions between 450 nm and 570 nm.

FIG. 5 depicts an alternative embodiment in which a liquid entity 22 is provided within a conduit 50 or receptacle (not shown). This makes it possible to detect a higher proportion of radiation emitted from the entity 22 in comparison to when embodiments of the type depicted in FIG. 3 are used to detect contamination in liquids. This is because, in the case where the apparatus of FIG. 3 floats on a body of liquid to be tested (e.g. via floats 48), a large proportion of radiation emitted by the entity 22 will be lost into the bulk of the entity by propagating downwards. If the liquid to be tested is constrained within a conduit 50 or receptacle it is easier to capture radiation emitted in multiple directions. This approach is particularly desirable in situations where the fluorescent signal is expected to be weak and the liquid does not represent a significant fouling risk, such as when the liquid is filtered potable water.

In some embodiments, the conduit 50 is an elongate conduit or the receptacle is an elongate receptacle. In such embodiments, the first optical concentrator 28, or a plurality of first optical concentrators 28, may be configured so that they azimuthally surround an axis of elongation (and/or an average direction of flow along the conduit in the case where the liquid entity flows along the conduit 50) through at least 180 degrees, optionally at least 270 degrees, optionally at least 300 degrees, optionally at least 330 degrees, optionally substantially or completely 360 degrees. In the case where the elongate conduit 50 or the elongate receptacle is cylindrical, the axis of elongation will be the axis of cylindrical symmetry.

FIG. 5 depicts an example of such a configuration comprising two first optical concentrators 28, provided above and below the elongate conduit 50. The first optical concentrators 28 capture radiation 30 emitted upwards and downwards. In the example shown, the first optical concentrators 28 are substantially planar, but other shapes are possible, including curved shapes that follow the geometry of an exterior surface of the elongate conduit 50.

FIG. 6 is an end view along an axis of elongation of the elongate conduit 5 of an alternative embodiment in which four planar first optical concentrators 28 are provided, including a first pair above and below the elongate conduit 50, and a second pair at 90 degrees to the first pair and provided on the left and right sides of the elongate conduit 50 (in the orientation of the figure).

FIG. 7 is an end view along an axis of elongation of the elongate conduit 5 of an alternative embodiment in which the first optical concentrator 28 is provided in tubular form, thereby completely surrounding the axis of elongation of the elongate conduit 50. In an embodiment, the first optical concentrator 28 itself acts as the transparent conduit 50, thereby obviating the need for a separate elongate conduit 50 to be provided.

FIG. 8 is an end view along an axis of elongation of the elongate conduit 5 of an alternative embodiment in which a plurality of first optical concentrators 28 are provided as fibres and arranged to surround the transparent conduit 50. In an embodiment, the axes of the fibres are substantially parallel with the axis of elongation of the elongate conduit 50.

Embodiments of the type discussed above with reference to FIGS. 5-8, which excite fluorescence in liquid entity contained in an elongate conduit 50 or elongate receptacle can also be provided within an enclosure (not shown) to reduce interference from ambient light. In the case where liquid is flowed continuously through the elongate conduit 50, the enclosure may be provided with suitable input and output ports to allow the liquid entity to enter and leave the enclosure.

In some embodiments, the elongate conduit 50 and/or elongate receptacle are at least partially transparent, at least in regions of the elongate conduit 50 or elongate receptacle where fluorescence is to be detected.

To boost signal strength it is desirable to arrange for the length over which the excitation radiation can be absorbed to be as long as possible. In the context of embodiments having an elongate conduit 50 or elongate receptacle, this may be achieved by arranging for the elongate conduit 50 or elongate receptacle to guide the excitation radiation generally along the axis of elongation (e.g. by total internal reflection). For eye safety, however, the elongate conduit 50 or elongate receptacle should be bent before it exits any enclosure so that at least some of the guided excitation light is made to escape before the elongate conduit or elongate receptacle exits the enclosure.

FIG. 9 depicts an example of an embodiment in which the apparatus 20 further comprises a reflection system 52 that redirects radiation emitted by the entity 22 towards the first optical concentrator 28 by reflection. In some embodiments, the reflection system 52 comprises one or more reflectors. By redirecting radiation towards the first optical concentrator 28 that might otherwise miss the first optical concentrator 28, the reflection system 52 increases the total amount of radiation received, without having to make the first optical concentrator 28 larger. Alternatively or additionally, the reflection system 52 can be configured to prevent ambient light from reaching the first optical concentrator 28. The reflection system 52 may therefore additionally act as an enclosure. Alternatively or additionally, the reflection system 52 may also act as a shield to prevent stray radiation from the excitation source compromising eye safety. In an embodiment, a proximity sensor 54 is provided that detects proximity between the apparatus 20 and the entity 22. The apparatus 20 may be configured to control operation of the excitation source 24 based on an output from the proximity sensor 54. For example, the apparatus 20 may be configured so that the excitation source is only operable above a given power level when it is detected that the entity 22 is located within a predetermined threshold distance of the apparatus 20 (e.g. such that a combination of the entity 22 and an enclosure 44 (where provided) or reflection system 52 (where provided) fully enclose the region in front of the excitation source 24 and make the arrangement eye safe).

The geometry shown in FIG. 9 is particularly suitable for scanning across surfaces that need to be checked for contamination without making contact with the surface. The geometry of the reflection system 52 and first optical concentrator 28 could take various forms, including extending linearly into the page to create an elongate element that could be scanned efficiently over a large surface to detect contamination. The reflection system 52 could thus comprise reflectors in the form of a V-shaped groove. In order to localise contamination detected during a sweep of the apparatus 20 in a first direction, the apparatus 20 could be swept across the surface a second time in a second direction (e.g. at 90 degrees to the first direction and with the reflector rotated by 90 degrees). In an alternative embodiment, instead of extending the cross-section of FIG. 9 linearly into the page as discussed above, the apparatus 20 could take a more circular form, such that the reflection system 52 would comprise a reflector having a frusto-conical form. This approach would provide a more spatially focused detection and thereby facilitate localisation of an area of contamination.

FIG. 10 depicts an example of an alternative configuration configured to facilitate localisation of an area of contamination by positioning the excitation source 24 so as to be surrounded by an input surface 32 of a first optical concentrator 28 (which may be annular for example). In an embodiment a detection system 38 is provided around a radially outer surface of the first optical concentrator 28. The embodiment of FIG. 10 could be implemented as a hand-held device and would be particularly practical in situations where the excitation source 24 is intrinsically eye safe and/or where shielding of the excitation source 24 is not necessary from a safety perspective.

In an embodiment, the apparatus 20 further comprises a filter configured to at least partially block input of excitation radiation into the first optical concentrator 28. In an embodiment of the type shown in FIG. 9, the reflection system 52 may comprises a filter 56 that selectively suppresses reflection of the excitation radiation 26 towards the first optical concentrator 28 relative to the radiation emitted by the entity 22 due to fluorescence excited by the excitation radiation 26. This may be provided via a coating on a reflector having a suitably selected wavelength-dependent reflectivity (such that radiation at the wavelength of the radiation 30 emitted by the entity 22 is much more strongly reflected than radiation at the wavelength of the excitation radiation 26). A filter may also be provided directly in front of the first optical concentrator 28 to prevent excitation radiation from entering the first optical concentrator 28.

In an embodiment, an example of which is depicted in FIG. 11, the apparatus 20 further comprises an excitation source monitor 60 that monitors an output from the excitation source 24. In an embodiment, the excitation source monitor 60 comprises a second wavelength converting element 62 that converts invisible radiation (e.g. UV) to visible radiation. The second wavelength converting element 62 may adopt any of the configurations described above for the first wavelength converting element 62. In an embodiment, the second wavelength converting element 62 is provided in an optical fibre (e.g. by doping an optical fibre by a chromophore) configured to allow radiation from the excitation source to enter the optical fibre through a side surface of the optical fibre (e.g. substantially radially), and the visible radiation is emitted at a longitudinal end surface of the optical fibre. In an embodiment, the second wavelength converting element 62 converts radiation output from the excitation source 24 from invisible radiation (e.g. UV) to visible radiation and outputs the visible radiation to the environment for direct viewing by a user. A user can then visually see when the excitation source 24 is on.

In an embodiment, the second wavelength converting element 62 is provided within a second optical concentrator 64. The second optical concentrator 64 may adopt any of the configurations described above for the first optical concentrator 28. The second optical concentrator 64 receives a portion of the excitation radiation 26 via an input surface (facing towards the excitation source 24) and outputs concentrated radiation via an output surface 66. The second wavelength converting element 62 converts received radiation to longer wavelength radiation prior to output of the radiation via the output surface 66. A detector 68 detects radiation output from the output surface 66 of the second optical concentrator 64. In an embodiment, the detector 68 detects radiation output from a first output surface 66 of the second optical concentrator 64 (on the right side in FIG. 11), and radiation output from a second output surface 66 of the second optical concentrator 64 (on the left side in FIG. 11) is emitted to the environment for direct viewing by a user of the apparatus 20.

In an embodiment, the data processing unit 40 of any of the embodiments discussed above is configured to use a combination of the detected radiation output from the output surface 34 of the first optical concentrator 28 and the monitored output from the excitation source 24 provided by the excitation source monitor 60 to determination information about contamination in or on the entity. The data processing unit 40 may for example take account of a measured intensity of the excitation source 24 (which may diminish over extended use of the apparatus or as the apparatus ages) to interpret the detected radiation output from the output surface 34 (e.g. to correct for any reduction in the intensity of the excitation source 24, which will reduce a level of radiation output from the output surface 34 for a given level of contamination).

Although discussed above as part of the apparatus 20 for measuring contamination, the excitation source monitor 60 can be provided as a separate unit together with the excitation source 24 to provide a self-contained radiation source. The radiation source is configured to emit invisible radiation (e.g. UV). The radiation source comprises a wavelength converting element 64 that converts a portion of the invisible radiation emitted by the radiation source to visible radiation and emit the visible radiation to the environment for direct viewing by user. The radiation source is thus able to provide a visual indication to a user that the radiation source is emitting radiation even though the radiation source itself emits only invisible radiation.

The entity 22 to which apparatus and methods of embodiments of the present disclosure may be applied may take various forms. In one class of embodiments, the entity 22 comprises liquid. In another class of embodiments, the entity comprises a solid surface.

1. An apparatus for optical detection of contamination, comprising:
an excitation source configured to direct excitation radiation into or onto an entity to be tested;
a first optical concentrator configured to: receive radiation emitted due to fluorescence indicative of contamination in or on the entity, the radiation being received via an input surface; and output concentrated radiation via an output surface, wherein the first optical concentrator comprises a first wavelength converting element configured to convert the received radiation to longer wavelength radiation prior to the output of the radiation via the output surface; and
a detection system configured to detect radiation output from the output surface of the first optical concentrator.

2. (canceled)

3. The apparatus of claim 1 or 2, further comprising:
a filter configured to at least partially block input of excitation radiation into the first optical concentrator; and
a reflection system configured to redirect the radiation emitted due to fluorescence towards the first optical concentrator,
wherein the reflection system comprises a filter configured to selectively suppress reflection of the excitation radiation by the reflection system towards the first optical concentrator.

4-5. (canceled)

6. The apparatus of claim 1, further comprising:
a modulator configured to apply a modulation to the excitation radiation such that a corresponding modulation is present in the emitted radiation received by the first optical concentrator; and
a data processing unit configured to use the results of the detection to determine information about contamination in or on the entity, wherein the data processing unit is configured to use the modulation applied by the modulator to distinguish between 1) detected radiation resulting from fluorescence excited by excitation radiation having the same modulation; and 2) other detected radiation.

7. (canceled)

8. The apparatus of claim 7, wherein:
the modulator is configured to apply modulation at a plurality of different modulation frequencies; and
the data processing unit is configured to distinguish between detected radiation with each of the different modulation frequencies.

9. The apparatus of claim 8, wherein:
the excitation radiation comprises a plurality of excitation components, each excitation component consisting of radiation within a different band; and
each excitation component is modulated at a different modulation frequency.

10. (canceled)

11. The apparatus of claim 8, wherein the data processing unit is configured to use a combination of the distinguished detected radiation from different modulations to extract levels of a plurality of different fluorophores in or on the entity that have different fluorescence decay lifetimes.

12. The apparatus of claim 6, wherein:
the excitation radiation comprises a plurality of excitation components, each excitation component consisting of radiation within a different band; and
each excitation component is modulated so as to be applied at a different time to each other excitation component.

13. The apparatus of claim 1, further comprising a plurality of the first optical concentrators, each first optical concentrator comprising a first wavelength converting element that is configured to convert received radiation in an input band to longer wavelength radiation in an output band, wherein at least the input band is different for each of two or more of the first optical concentrators.

14. The apparatus of claim 1, further comprising a plurality of the first optical concentrators, each of one or more of the first optical concentrators comprising a filter configured to block entry into the first optical concentrator of a range of wavelengths other than a range of wavelengths associated with the excitation source.

15. The apparatus of claim 13, wherein the plurality of first optical concentrators are arranged in series with each other.

16. The apparatus of claim 1, further comprising an excitation source monitor configured to monitor an output from the excitation source,
wherein the excitation source monitor comprises a second wavelength converting element configured to convert invisible radiation to visible radiation and output the visible radiation to the environment for direct viewing by a user.

17. (canceled)

18. The apparatus of claim 1, wherein the second wavelength converting element is provided in an optical fibre configured to allow radiation from the excitation source to enter the optical fibre through a side surface of the optical fibre, and the visible radiation is emitted at a longitudinal end surface of the optical fibre.

19. The apparatus of claim 16, wherein:
the excitation source monitor comprises a second wavelength converting element within a second optical concentrator, the second optical concentrator being configured to receive a portion of the excitation radiation via an input surface and output concentrated radiation via an output surface, the second wavelength converting element being configured to convert received radiation to longer wavelength radiation prior to output of the radiation via the output surface; and
a detector configured to detect radiation output from the output surface of the second optical concentrator.

20. The apparatus of claim 19, wherein the detector is configured to detect radiation output from a first output surface of the second optical concentrator, and radiation output from a second output surface of the second optical concentrator is emitted to the environment for direct viewing by a user of the apparatus.

21. The apparatus of claim 16, comprising a data processing unit configured to use a combination of the detected radiation output from the output surface of the first optical concentrator and the monitored output from the excitation source to determine information about contamination in or on the entity.

22. The apparatus of claim 1, further comprising an enclosure capable of at least partially optically isolating at least a portion of the entity being tested, during the receiving of the emitted radiation by the first optical concentrator, from the outside environment.

23. The apparatus of claim 1, further comprising a proximity sensor for detecting proximity between the apparatus and the entity, wherein the apparatus is configured to control operation of the excitation source based on an output from the proximity sensor,
configured such that the excitation source is operable exclusively when the proximity sensor detects that the entity is located within a predetermined threshold distance of the apparatus.

24. (canceled)

25. The apparatus of claim 1, further comprising an elongate conduit or elongate receptacle comprising an entity to be tested in liquid form, wherein the first optical concentrator, or a plurality of first optical concentrators, azimuthally surround an axis of elongation of the elongate conduit or elongate receptacle through at least 180 degrees.

26-28. (canceled)

29. A method for optical detection of contamination, comprising:
directing excitation radiation into or onto an entity to be tested;
using a first optical concentrator to receive radiation emitted due to fluorescence indicative of contamination in or on the entity, the radiation being received via an input surface, and to output concentrated radiation via an output surface, wherein the first optical concentrator comprises a first wavelength converting element that converts the received radiation to longer wavelength radiation prior to the output of the radiation via the output surface; and
detecting radiation output from the output surface of the first optical concentrator.

30-36. (canceled)

37. The method of claim 29, wherein the entity comprises a flowing liquid and the first optical concentrator azimuthally surrounds an axis of the flow by at least 180 degrees.
